(19) United States
(12) Patent Application Publication
(10) Pub. No.: US 2006/0151748 A1
(43) Pub. Date: Jul. 13, 2006

(54) Process for cast detergent manufacture

(75) Inventors: Amit Kumar Chaudhary, Bangalore (IN); Jiji Paul Kottukapally, Bangalore (IN); Krishnan Venkateswaran, Bangalore (IN)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/301,437

(22) Filed: Dec. 13, 2005

(30) Foreign Application Priority Data
Dec. 15, 2004 (IN) 1341/MUM/2004

(51) Int. Cl. C11D 15/00

(52) U.S. Cl. 252/367.1

(57) ABSTRACT

The present invention provides for a process to prepare multi-phase cast solid detergent log capable of being cut into plurality of bars comprising: i. positioning a rigid insert into a rigid elongate mould wherein the insert is substantially coextensive with the mould, to define a cavity in the elongate mould; ii. filling melt of a detergent composition into the cavity; iii. cooling the detergent composition to promote solidification of the melt; and iv. ejecting the solid detergent log from the elongate mould.

The present invention relates to a process for the casting of multi-phase solid detergent bars.

Soap or non-soap detergent articles are traditionally produced either by extrusion or by casting routes.

The processing of a detergent article via the extrusion route involves various operations such as homogenisation, shear working, and forming into a suitable shape. A plodder or extruder is employed to take care of part of the shaping operation. The product from the extruder is cut into logs and/or billets which are subsequently stamped and shaped into tablets or bars. The extrusion of soap or detergent mass is a continuous operation.

The casting route for detergent bars is traditionally employed for producing highly transparent soaps. To enable casting, the detergent compositions should be capable of being molten without charring at reasonable temperatures, say in the range of 60 to 150° C., and should be in the solid state at ambient conditions, e.g. temperatures in the range of 20 to 40° C. Casting can be carried out in unitary moulds. The unitary moulds are capable of being cooled, and are in the size and shape of the individual bars. The moulds are filled with the melt of the detergent composition, and allowed to cool to form the bar. The bar is then ejected from the mould.

Another technology involves casting of molten soap into logs of desired cross section in rigid elongate moulds e.g. in a Schicht cooler which is a tubular mould, where the melt is filled, cooled, the log ejected, cut into individual bars, optionally chamfered, and stamped to produce individual soap bars.

Multi-phase detergent bars are preferred by the consumers both from the visual appeal of the bar, and from the functional benefit delivered. The different phases may simply have different colours, or one phase of the bar may be transparent while another may be opaque, or the different phases may be distinct detergent compositions. In some multi-phase bars, one phase may have benefit agent to be delivered to the substrate, while the other phase may have a purely cleaning function. Alternately the composition of each phase may be distinct, and different benefit agents may be delivered from the different phases.

The present inventors have developed a novel and highly cost-effective process to prepare a multi-phase cast solid detergent log capable of being cut into a plurality of bars, more particularly a log in which at a cross section of the log, at least one of the phases is completely bounded by another phase.

Many methods to prepare multi-phase detergent bars-have been disclosed.

EP 0141444 (Calstock Corp. 1985) discloses a method of manufacturing a compound cake of soap in which differently coloured parts of material are joined, characterized in that into a first part of material to be formed is inserted a formed, cured second part of material so that by forming the first part of material the second part of material is enclosed on all sides by the first part of material. This publication discloses a method of making the compound cake of soap by inserting a solid portion into a cavity in a preformed solid cake. This process is also cumbersome, since this process step has to be repeated on each cake of soap.

WO0202729 (Ovation, 2002) discloses an article of soap including a first element of soap having a first visual characteristic and a second element of soap extending through the first element, the second element of soap having a second visual characteristic visually distinct from the first visual characteristic. The publication also describes methods for forming the article of soap which include co-extrusion or forming the elements independently by stamping or moulding, and then assembling the two elements to form the combined soap bar. This publication teaches extruding the two elements together (co-extrusion) which is not possible with many melt-cast compositions. Also assembling the two pre-formed solid elements into a soap bar for each and every bar of soap is a cumbersome process.

U.S. Pat. No. 6,376,441 (Unilever, 2002) discloses a melt casting process for making a multi-layer toilet bar, comprising the steps of: (i) positioning at least one removable, formed divider along a plane perpendicular to the plane formed by the x and y axis of the bar in a unitary mold having a cavity, to form at least two cavities; (ii) pouring a first molten cleansing material into a first cavity, defined by the mold and the at least one removable divider; (iii) cooling the first molten cleansing material until it is hardened; (iv) removing the at least one divider from the mold; (v) pouring a second molten cleansing material into a second mold cavity defined by the hardened first cleansing material and the mold; (vi) cooling the second molten cleansing material until it is hardened; and (viii) ejecting a hardened multi-layered toilet bar casting from the mold. The process disclosed is cumbersome, since the multi-layer toilet bars are manufactured by the sequence of steps which have to be carried out for each unitary mould. More over, the publication does not teach methods to prepare multi-phase bar where one phase is completely bounded by another.

It is thus an object of the invention to be able to provide for a process to prepare multi-phase cast solid detergent log which is capable of being cut into a plurality of bars.

It is another object of the invention to be able to provide for a process to prepare multi-phase cast solid detergent log which is capable of being cut into a plurality of bars in which one of the phases is completely bounded by one or more of other phases in a cross-section.

It is yet another object of the invention to be able to provide for a process to prepare multi-phase cast solid detergent log which is capable of being cut into a plurality of bars in which one of the phases is completely bounded by one or moe of other phases in a cross-section, in a convenient and cost-effective manner with high production throughput.

According to the present invention there is provided a process to prepare multi-phase cast solid detergent log capable of being cut into plurality of bars comprising:
i. positioning a rigid insert into a rigid elongate mould wherein the insert is substantially co-extensive with the mould, to define a cavity in the elongate mould;
ii. filling melt of a detergent composition into the cavity;
iii. cooling the detergent composition to promote solidification of the melt; and
iv. ejecting the solid detergent log from the elongate mould.

According to a preferred aspect of the invention, there is provided a process to prepare a multi-phase cast solid detergent log capable of being cut into plurality of bars comprising:
i. positioning a rigid insert into a rigid elongate mould wherein the insert is substantially co-extensive with the mould, to define a cavity in the elongate mould;
ii. filling melt of first detergent composition into the cavity;
iii. cooling the detergent composition to promote solidification of the melt;
iv. ejecting the insert to define a cavity;
v. filling melt of second detergent composition into the cavity;
vi. cooling the melt to promote solidification; and
vii. ejecting the solid detergent log from the elongate mould.

The invention provides for a process to prepare multi-phase cast solid detergent log which is capable of being cut into a plurality of bars in a rigid elongate mould. The term ‘multi-phase’ as per the present invention, is used to mean distinct compositions. Thus the phrase multi-phase cast solid detergent means a solid detergent product which has two or more detergent compositions which are spatially distinct. It is also possible that one or more phases of the log is present as a gel or a structured semi-solid mass at ambient temperatures, while ensuring the integrity of the log and the bars cut therefrom during storage and use. The detergent bars of the present invention preferably comprise soap.

The cross-section of the mould is chosen based on the desired shape of the detergent bar. Although any shape may be used, the most preferred cross-sectional shapes of the rigid elongate mould are rectangular, square, circular and oval. The rigid elongate mould is capable of being cooled to ensure that the molten detergent composition filled therein can be efficiently cooled and solidified. Preferred cooling arrangement is jacketing the mould, and cooling is enabled by circulating cooling water through the jacket. A preferred arrangement of the mould is the Schicht cooler.

It is possible as per this invention to have a plurality of inserts. The rigid inserts are substantially co-extensive with the mould, preferably co-axial. The rigid inserts may be:
(i) a solid log of detergent which is prepared separately either by casting or by extrusion, and is inserted axially into the rigid mould and is substantially co-extensive with the mould; or
(ii) a rigid hollow or solid block of any other material which is substantially co-extensive with the mould and capable of being ejected from the rigid tubular mould.

When the solid log of detergent is the insert, it is one of the phases in the multi-phase solid detergent log. The solid log of detergent is prepared separately either by casting or by extrusion, preferably by casting. The solid insert may also be an extruded bar, prepared separately and inserted in the elongate mould. Such an extruded log insert is especially preferred when it is desirable to have temperature sensitive actives such as e.g. an antiperspirant like aluminium chlorohydrate, which can be present in the extruded log, but which would degrade at the temperatures of a melt cast composition.

Additionally, when it is desirable to include particulates, these could be included in an extruded log insert since particulates which have a high density difference with a melt cast composition would tend to settle by gravity to the bottom of the elongate mould during cooling and solidification, thus giving a poor quality non-uniform detergent log. The cross-sectional shape of the phase of the detergent log insert is chosen as desired, and may be square, rectangular, circular, oval or any irregular shape. It is preferred that the cross-sectional shape of the insert is of the same shape as the rigid elongate mould. When this is inserted as the rigid insert in the rigid elongate mould, the remaining space in the mould is filled with the melt of the detergent composition of the other phase. The melt is then allowed to cool to form a composite log of the multi-phase detergent composition. The composite log is then ejected, and optionally cut into individual bars, and chamfered and stamped as desired.

When the rigid insert is of any other material, it may be hollow or solid, preferably hollow, and is capable of being removed from the rigid elongate mould. When the rigid insert is hollow, it is preferably jacketed; when the rigid insert is hollow e.g. a hollow tube inserted co-axial with the elongate mould, cooling water can be circulated in the annular space in the mould to cool and solidify the melt filled in the hollow insert. The other material is preferably metallic, and is preferably chosen from stainless steel, cast iron, copper or brass, most preferably stainless steel. In this aspect of the invention, the melt of a detergent composition is filled in one of the cavities defined by positioning one or more of the rigid inserts in the rigid elongate mould. The detergent composition thus filled is cooled to a solid state. The rigid insert is then removed from the rigid elongate mould. The cavity thus formed is then filled with another detergent composition.

The entire multi-phase detergent composition in the mould is then allowed to cool to a solid state to form a composite log. The composite log is then ejected from the mould, optionally cut into a plurality of detergent bars, and optionally chamfered and stamped.

When the two or more phases of the multi-phase cast solid detergent log do not have good adhesive binding between them, the process of the invention may be used to prepare the detergent log wherein the individual phases are mechanically interlocked.

The invention with now be illustrated by way of example only with reference to the following non-limiting exemplary embodiments of the process as per the invention, in which:

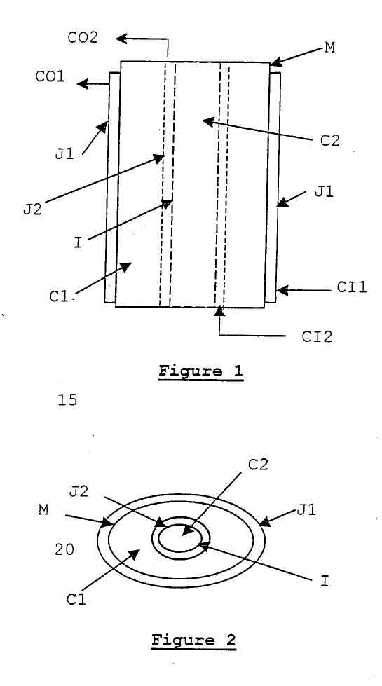

FIG. 1 is a front view of a rigid elongate mould with the jacketed rigid insert indicated as dotted lines for preparation of a multi-phase cast solid log of detergent;

FIG. 2 is the top view of the mould of FIG. 1;

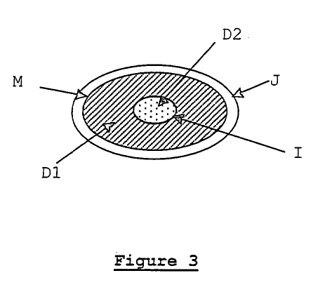

FIG. 3 is the top view of the mould of FIG. 1 on formation of the multi-phase cast solid detergent log; and

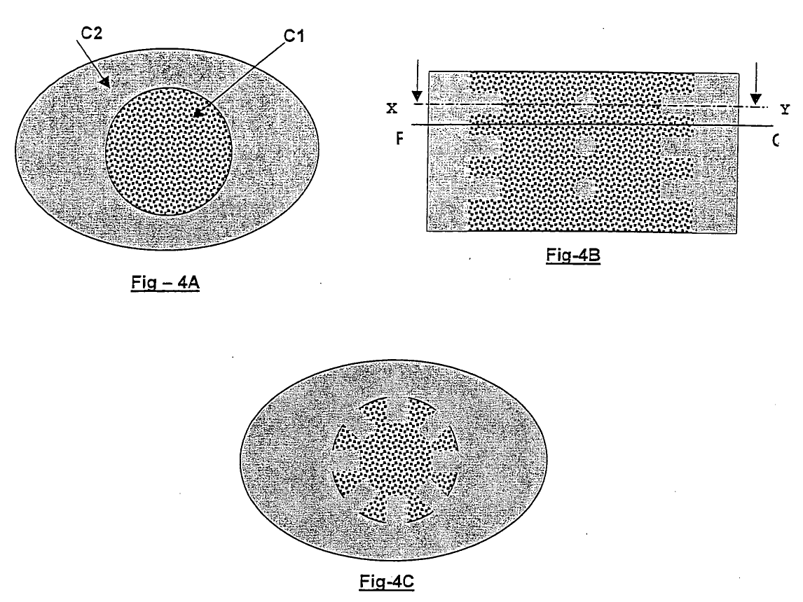

FIG. 4A, 4B and 4C are the top, front and sectional view of a multi-phase cast detergent log which has the two different phases in a mechanically interlocked configuration.

Referring to the drawings, FIG. 1 is the front view of a rigid elongate mould (M) made of stainless steel. The mould is provided with a jacket (J1) which has a cooling water inlet (CI1) and a cooling water outlet (CO1). FIG. 2 is the top view of the mould of FIG. 1, which shows that the mould (M) has an oval cross-section.

When in use rigid insert (I), also made of stainless steel, and having an oval cross-section, is inserted and positioned into the mould (M) as shown in the FIGS. 1 and 2 to define two cavities (C1, C2). The jacket of the rigid tubular insert has a cooling water inlet (CI2) and a cooling water outlet (CO2). Melt of a detergent composition (D2) is prepared and poured into cavity C2. See Table 1 for the detergent composition of D2. Cooling water is circulated through the jacket (J2) to enable cooling and solidification of the detergent composition D2 in the rigid tubular insert. Once D2 has solidified, the insert (I) is removed from the mould (M)

Melt of another detergent composition D1 is prepared and filled in the cavity C1, and is allowed to cool to solidification by circulation of cooling water through the jacket J1 to prepare a multi-phase detergent composition, the top view of which is shown in FIG. 3. See Table 1 for the detergent composition of D1. The solid composition is then ejected from the mould M as a log. The log is then cut in the transverse direction into individual bars, chamfered and stamped for packing.

TABLE 1

| | % by | | % by |
|---|---|---|---|
| D1 | weight | D2 | weight |
| Total fatty matter | 41 | Total fatty matter | 41 |
| (TFM) | | (TFM) | |
| Polyhydric alcohol | 36 | Polyhydric alcohol | 36 |
| Sodium lauryl | 6 | Sodium lauryl | 6 |
| sulphate | | sulphate | |
| Ethanol | 2 | Ethanol | 2 |
| Colour | Green dye | Colour | Amber dye |
| Water | To 100 | Water | To 100 |

Referring further to the drawings, FIG. 4A is a top view of a two phase cast detergent composition with the two phases marked C1 and C2. FIG. 4B is a front view of the cast detergent log which clearly shows the two phases in mechanical interlocking configuration with respect to each other. FIG. 4C is a cross-sectional view of the log along the lines X-Y of FIG. 4B.

When in use, the cast or extruded log having the front view of C1 of FIG. 4B is inserted in the mould, around which the molten composition of C2 is poured and allowed to cool to solidification. The log is then ejected from the mould, and cut along the lines P-Q to prepare the individual detergent bars having the top view of FIG. 4A.

The invention thus provides for a process to prepare multi-phase cast detergent logs capable of being cut into bars. The process also enables preparation of bars in which one of the phases is completely bounded by one or more of other phases in a cross-section. Additionally, the invention enables this in a convenient and cost-effective manner at a high production rate.

1. A process to prepare multi-phase cast solid detergent log capable of being cut into plurality of bars comprising:
i. positioning a rigid insert into a rigid elongate mould wherein the insert is substantially co-extensive with the mould, to define a cavity in the elongate mould;
ii. filling melt of a detergent composition into the cavity;
iii. cooling the detergent composition to promote solidification of the melt; and
iv. ejecting the solid detergent log from the elongate mould.

2. A process as claimed in claim 1 wherein the rigid insert is a cast solid detergent composition.

3. A process as claimed in claim 1 wherein the rigid insert is a hollow or solid block.

4. A process as claimed in claim 3 wherein the rigid insert is a hollow block.

5. A process as claimed in claim 4 wherein the block is metallic.

6. A process as claimed in claim 3 wherein after cooling the detergent composition to promote solidification of the melt, the process comprises the steps of:
i. ejecting the insert to define a cavity;
ii. filling melt of a second detergent composition into the cavity; and
iii. cooling the melt to promote solidification.

7. A process as claimed in claim 1 wherein the rigid elongate mould has a rectangular, square, circular or oval cross-section.

8. A process as claimed in claim 7 wherein the rigid elongate mould has a circular or oval cross-section.

9. A process as claimed in claim 1 wherein the rigid insert has the same cross-sectional shape as the rigid elongate mould.

10. A process as claimed in claim 1 wherein the rigid insert is co-axial with the rigid elongate mould.

11. A process as claimed in claim 1 comprising a plurality of rigid inserts.

12. A process as claimed in claim 1 wherein the rigid elongate mould is jacketed.

13. A process as claimed in claim 1 wherein the solid detergent log is cut into a plurality of bars, the bars are chamfered and stamped.

14. A process as claimed in claim 1 wherein the detergent composition comprises soap.
